(19) United States
(12) Patent Application Publication
(10) Pub. No.: US 2026/0361206 A1
(43) Pub. Date: Nov. 12, 2026

(54) GATE DRIVERS FOR GALLIUM NITRIDE BASED POWER SWITCHES

(71) Applicant: GM Global Technology Operations LLC, Detroit, MI (US)

(72) Inventors: Mohamed Ahmed Kamel Ahmed, Birmingham, MI (US); Chandra S. Namuduri, Troy, MI (US); Yilun Luo, Ann Arbor, MI (US)

(73) Assignee: GM Global Technology Operations LLC, Detroit, MI (US)

(21) Appl. No.: 19/205,391

(22) Filed: May 12, 2025

(51) Int. Cl. H02M 1/08; B60L 50/51

(52) U.S. Cl. CPC H02M 1/08; B60L 50/51

(57) ABSTRACT

A circuit includes a power switch comprising a gallium nitride (GaN) based gate injection transistor (GiT), and a gate driver configured to, responsive to a first control input from a controller, generate, from a positive power-supply voltage, a positive voltage and a first current at a gate of the switch to turn the switch on, wherein the first current comprises a switch current during a first time period and a hold current during a second time period following the first time period, wherein the switch current is greater than the hold current. The driver is also configured to, responsive to a second control input from the controller, generate, from a negative power-supply voltage, a negative voltage and a second current at the gate to turn the switch off. The driver is further configured to provide at the gate a low impedance while the power switch is turned off.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

Electric vehicles (EVs) and hybrid electric vehicles (HEVs) include one or more electric motors, an inverter, and one or more battery packs configured to provide electric voltages for powering the electric motor(s) to propel the vehicle and/or to provide other electric voltages used by other components of the vehicle. The inverter includes a plurality of power switches for converting direct current (DC) electric voltages provided by the battery pack(s) into alternating current (AC) electric voltages for powering the electric motor(s).

The present disclosure relates generally to gate drivers for gallium nitride (GaN) based power switches.

### SUMMARY

One aspect of the disclosure provides a vehicle including a battery control module, an electric motor, a battery configured to provide a direct-current (DC) voltage for powering the electric motor, an inverter including a plurality of power switches, and a plurality of gate drivers for respective ones of the plurality of power switches. The power switches are configured to generate, based on the DC voltage, an alternating-current (AC) voltage for powering the electric motor, wherein each power switch includes a gallium nitride (GaN) based gate injection transistor (GiT). Each gate driver is configured to, responsive to a first control input from the battery control module, generate, from a positive power-supply voltage that is isolated from the DC voltage, a positive voltage and a first current at a gate of the power switch to turn the power switch on, and, responsive to a second control input from the battery control module, generate, from a negative power-supply voltage that is isolated from the DC voltage, a negative voltage and a second current at the gate of the power switch to turn the power switch off.

Implementations of the disclosure may include one or more of the following optional features. In some implementations, each gate driver includes an isolated amplifier and a drive circuit. In some configurations, the isolated amplifier includes a first input connected to the positive power-supply voltage, a second input connected to the negative power-supply voltage, a first output, and a second output connected to the gate of the power switch; and the drive circuit includes a first resistor connected between the first output and the gate, a second resistor and a capacitor connected in series between the first output and the gate of the power switch, and a diode connected in parallel with the capacitor. In some examples, the isolated amplifier is configured to generate, based on the positive power-supply voltage, an output voltage; and the drive circuit is configured to generate, based the output voltage of the isolated amplifier, the first current to include a switch current during a first time period, and a hold current during a second time period following the first time period, wherein the switch current is greater than the hold current. In some implementations, the gate driver is configured to adjust the hold current based on temperature. In some examples, the drive circuit includes a resistor connected in series with the gate of the power switch and having a resistance that changes with temperature to adjust the hold current based on temperature. In some configurations, the isolated amplifier is further configured to provide at the gate of the power switch a low impedance while the power switch is turned off.

In some examples, the vehicle also includes a controller configured to perform operations including controlling the isolated amplifier responsive to the first and second control inputs from the battery control module. In some implementations, the operations also include controlling the isolated amplifier to adjust a hold current portion of the first current based on temperature. In some configurations, the operations also include detecting excessive current in the gate driver and, based on detecting the excessive current, turning the power switch off.

In some configurations, the vehicle also includes an isolated power-supply circuit configured to generate the positive power-supply voltage and the negative power-supply voltage from the DC voltage. In some examples, the isolated power-supply circuit includes one or more of external isolation windings or isolation windings embedded in a printed circuit board. In some implementations, the vehicle also includes an application specific integrated circuit (ASIC) including one or more of the plurality of gate drivers.

Another aspect of the disclosure provides a circuit including a power switch including a gallium nitride (GaN) based gate injection transistor (GiT), and a gate driver. The gate driver is configured to: responsive to a first control input from a controller, generate, from a positive power-supply voltage, a positive voltage and a first current at a gate of the power switch to turn the power switch on, wherein the first current includes a switch current during a first time period and a hold current during a second time period following the first time period, wherein the switch current is greater than the hold current; responsive to a second control input from the controller, generate, from a negative power-supply voltage, a negative voltage and a second current at the gate of the power switch to turn the power switch off; and provide at the gate of the power switch a low impedance while the power switch is turned off.

Implementations of the disclosure may include one or more of the following optional features. In some implementations, the gate driver includes a drive circuit configured to generate the first current to include a switch current during a first time period, and a hold current during a second time period following the first time period, wherein the switch current is greater than the hold current. In some configurations, the drive circuit includes a resistor configured to have a resistance that changes with temperature to adjust the hold current based on temperature.

In some examples, the gate driver is configured to provide at the gate of the power switch a low impedance while the power switch is turned off. In some configurations, the gate driver includes an isolated amplifier configured to, responsive to the first and second control inputs, generate the positive voltage and the negative voltage. In some implementations, the gate driver is configured to detect excessive current in the gate driver, and, based on detecting the excessive current, turn the power switch off.

In some configurations, the circuit also includes an isolated power-supply circuit configured to generate the positive power-supply voltage and the negative power-supply voltage from a DC voltage provided by a battery.

### BRIEF DESCRIPTION OF THE DRAWINGS

The drawings described herein are for illustrative purposes only of selected configurations and are not intended to limit the scope of the present disclosure.

FIG. 1 is a view of an example vehicle including a propulsion system in accordance with the principles of the present disclosure.

FIG. 2 is a schematic view of the propulsion system of FIG. 1.

FIG. 3 is an inverter circuit for the propulsion system of FIG. 2.

FIG. 4 is a gate driver for a high-current gallium nitride (GaN) based gate injection transistor (GiTs) power switch in accordance with the principles of the present disclosure.

FIG. 5 is a flowchart of an example arrangement of operations for operating the gate driver of FIG. 4.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Unless expressly stated to the contrary, the phrase “at least one of A, B, or C” is intended to refer to any combination or subset of A, B, C such as: (1) at least one A alone; (2) at least one B alone; (3) at least one C alone; (4) at least one A with at least one B; (5) at least one A with at least one C; (6) at least one B with at least C; and (7) at least one A with at least one B and at least one C. Moreover, unless expressly stated to the contrary, the phrase “at least one of A, B, and C” is intended to refer to any combination or subset of A, B, C such as: (1) at least one A alone; (2) at least one B alone; (3) at least one C alone; (4) at least one A with at least one B; (5) at least one A with at least one C; (6) at least one B with at least one C; and (7) at least one A with at least one B and at least one C. Furthermore, unless expressly stated to the contrary, “A or B” is intended to refer to any combination of A and B, such as: (1) A alone; (2) B alone; and (3) A and B.

Electric vehicles (EVs) and hybrid electric vehicles (HEVs) include one or more electric motors, an inverter, and one or more battery packs configured to provide electric voltages for powering the electric motor(s) to propel the vehicle and/or to provide other electric voltages used by other components of the vehicle. The inverter includes a plurality of power switches for converting direct current (DC) electric voltages provided by the battery pack(s) into alternating current (AC) electric voltages for powering the electric motor(s). In some implementations, the power switches of the inverter are high-current, gallium nitride (GaN) based, gate injection transistor (GiT) power switches, which may be controlled to convert DC voltages to AC voltages for EVs and HEVs. The present disclosure relates generally to gate drivers for GaN-based GiT power switches.

While examples are shown and described herein in connection with the inverter of an EV or HEV (e.g., an automobile, a truck, a motorcycle, etc.), it should be understood that disclosed configurations may additionally, or alternatively, be used for controlling high-current GaN-based GiT power switches for any other vehicles, devices, systems, and/or applications.

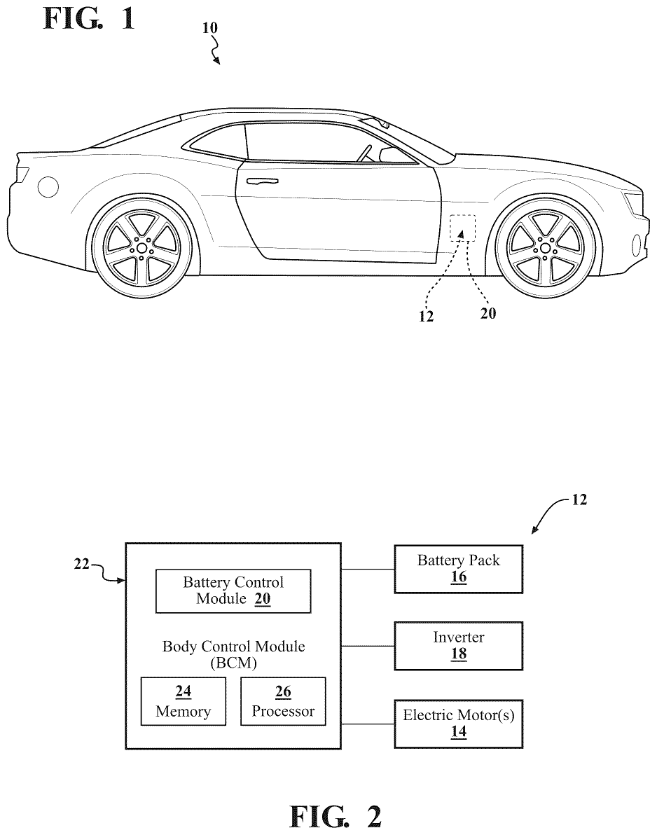

With particular reference to FIGS. 1, 2, 3, and 4, a vehicle 10 (e.g., an automobile, a truck, a motorcycle, etc.) is shown in conjunction with a propulsion system 12 configured to propel the vehicle 10. The vehicle 10 may be, for example, an EV or an HEV. The propulsion system 12 includes one or more electric motors 14, a battery pack 16 including one or more battery cells, and an inverter 18. The battery pack 16 is configured to provide a direct-current (DC) voltage for powering the electric motor(s) 14 and/or to provide other electric voltages used by other components of the vehicle 10.

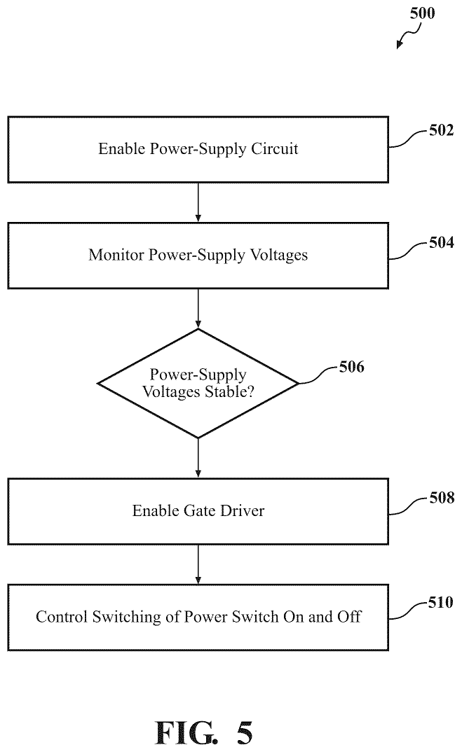

The propulsion system 12 also includes a battery control module 20 configured to control the battery pack 16 and the electric motor(s) 14 to propel the vehicle 10. The battery control module 20 may be executed on, for example, a body control module (BCM) 22 or any other controller or control module of the vehicle 10. The BCM 22 stores machine-readable instructions for executing the battery control module 20 on, for example, memory hardware 24 (e.g., a memory). The instructions may be executed by data processing hardware 26 (e.g., a processor) of the BCM 22 to execute the battery control module 20. Here, the battery control module 20 may perform the operations shown in FIG. 5, or operations described elsewhere in the present disclosure.

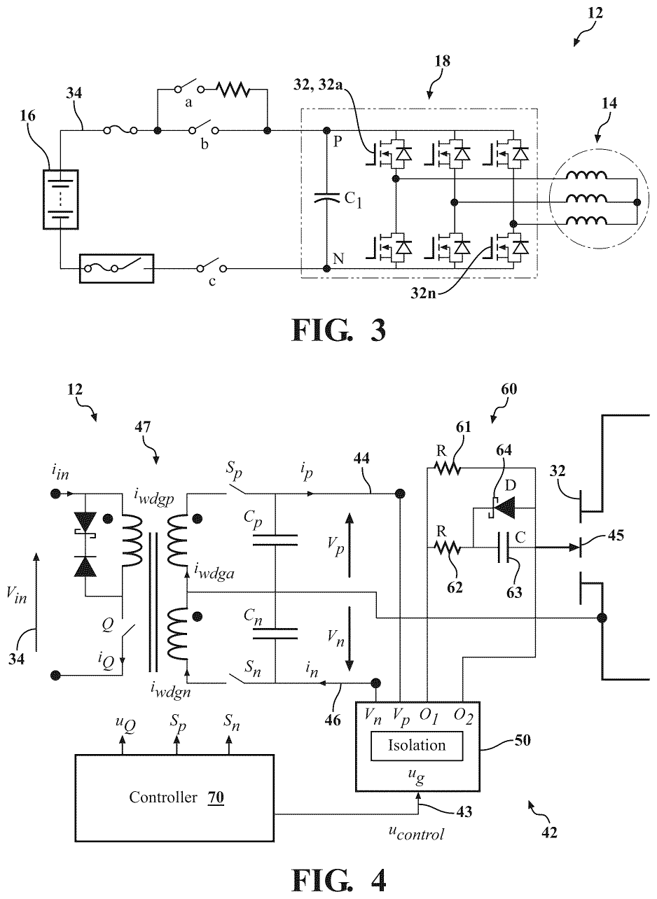

As shown in FIG. 3, the inverter 18 includes a plurality of power switches 32, 32a-n configured to generate, based on a DC voltage 34 provided by the battery pack 16, an AC voltage for powering the electric motor(s) 14. Here, each power switch 32 includes a high-current GaN-based GiT power switch.

As shown in FIG. 4, each power switch 32 has a respective gate driver 42 for controlling a switch state (e.g., ON and OFF) of the power switch 32. The gate driver 42 is configured to, responsive to a switch-on control input 43 from a controller 70 (e.g., the battery control module 20), generate, from a positive power-supply voltage 44, a switch-on positive voltage and a current at a gate 45 of the power switch 32 to turn on the power switch 32. The gate driver 42 is also configured to, responsive to a switch-off control input 43 from the controller 70, generate, from a switch-off negative power-supply voltage 46, a negative voltage and a current at the gate 45 of the power switch 32 to turn off the power switch 32.

In some implementations, the propulsion system 12 includes an isolated power-supply circuit 47 configured to generate, from the DC voltage 34 provided by the battery pack 16, the positive power-supply voltage 44 and the negative power-supply voltage 46. In some implementations, the isolated power-supply circuit 47 includes one or more of external isolation windings or isolation windings embedded in a printed circuit board (PCB) that are configured to isolate the power-supply voltages 44, 46 from the battery pack 16. In some configurations, the isolated power-supply circuit 47 is shared by multiple gate drivers 42. Alternatively, each gate driver 42 has an associated respective power-supply circuit 47. In some examples, the controller 70 (e.g., the battery control module 20) provides control inputs for controlling the isolated power-supply circuit 47. In the illustrated example, the isolated power-supply circuit 47 includes an oscillator.

In the illustrated example, each gate driver 42 includes a respective isolated amplifier 50 and a respective drive circuit 60. Here, the isolated amplifier 50 includes a first input vₚ connected to the positive power-supply voltage 44, a second input vₙ connected to the negative power-supply voltage 46, a first output o₁, and a second output o₂ connected to the gate 45 of the power switch 32. The gate driver 42 includes, or is in communication with, the controller 70 (e.g., the battery control module 20) for controlling the gate driver 42 response to control inputs from the controller 70. The controller 70 stores machine-readable instructions on memory hardware (e.g., memory) that, when executed by data processing hardware (e.g., a processor), causes the data processing hardware to perform operations for controlling the gate driver 42. Here, the controller 70 may perform the operations shown in FIG. 5, or operations described elsewhere in the present disclosure.

In the illustrated example, the drive circuit 60 includes a first resistor 61 connected between the first output o₁ of the isolated amplifier 50 and the gate 45 of the power switch 32, a second resistor 62 and a capacitor 63 connected in series between the first output o₁ and the gate 45 of the power switch 32, and a diode 64 connected in parallel with the capacitor 63. In some configurations, the drive circuit 60 includes an active Miller clamp and/or a snubber circuit to minimize parasitic oscillations.

The isolated amplifier 50 and drive circuit 60 are configured to, responsive to a switch-on control input 43 from the controller 70 (e.g., the battery control module 20), generate, from the positive power-supply voltage 44 a switch-on positive voltage and a current at the gate 45 of the power switch 32 to turn on the power switch 32. Here, the drive circuit 60 is configured to generate, based the output voltage output o₁ of the isolated amplifier 50, the current to include an initial high or peak switch current during a first time period, and a lower hold current during a second time period following the first time period. Here, the switch current is greater than the hold current to decrease a switching time of the power switch 32. In some examples, the gate driver 42 is configured to adjust the hold current based on temperature. In some implementations, the resistor 62 has a resistance that changes with temperature to adjust the hold current based on temperature.

The isolated amplifier 50 and drive circuit 60 are also configured to, responsive to a switch-off control input 43 from the controller 70 (e.g., the battery control module 20), generate, from the negative power-supply voltage 46 a switch-off negative voltage and a current at the gate 45 of the power switch 32 to turn off the power switch 32. In some implementations, the isolated amplifier 50 is configured to present a low impedance at the gate 45 of the power switch 32 when the power switch 32 is turned off.

In some examples, the controller 70 is configured to detect excessive current in the gate driver 42 and, based on detecting the excessive current, turn off the power switch 32. In some implementations, the isolated amplifier 50, the drive circuit 60, and the controller 70 are implemented together in an application specific integrated circuit (ASIC).

FIG. 5 is a flowchart of an example arrangement of operations for operating the gate driver 42 of FIG. 4 or, more generally, for operating a gate driver for a high-current GaN-based GiT power switch. The operations may be performed by data processing hardware (e.g., the data processing hardware 26) based on executing instructions stored on memory hardware (e.g., the memory hardware 24). Many other ways of implementing the method 500 may be employed. For example, the order of execution of the operations may be changed, and/or one or more of the operations and/or interactions may be changed, eliminated, sub-divided, or combined. Additionally, the operations of FIG. 5 may be carried out sequentially and/or in parallel by, for example, separate processing threads, processors, devices, discrete logic, circuits, etc.

At operation 502, the method 500 includes enabling the power-supply circuit 47. At operation 504, the method 500 includes monitoring the power-supply voltages 44 and 46 of the power-supply circuit 47. When the power-supply voltages 44, 46 are stable at operation 506, the method 500 includes enabling the gate driver 42 at operation 508. At operation 510, the method 500 includes controlling the isolated amplifier 50 to turn the power switch 32 on and off.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A vehicle comprising:
a battery control module;
an electric motor;
a battery configured to provide a direct-current (DC) voltage for powering the electric motor;
an inverter comprising a plurality of power switches configured to generate, based on the DC voltage, an alternating-current (AC) voltage for powering the electric motor, wherein each power switch comprises a gallium nitride (GaN) based gate injection transistor (GiT); and
a plurality of gate drivers for respective ones of the plurality of power switches, wherein each gate driver is configured to:
responsive to a first control input from the battery control module, generate, from a positive power-supply voltage that is isolated from the DC voltage, a positive voltage and a first current at a gate of the power switch to turn the power switch on; and
responsive to a second control input from the battery control module, generate, from a negative power-supply voltage that is isolated from the DC voltage, a negative voltage and a second current at the gate of the power switch to turn the power switch off.

2. The vehicle of claim 1, wherein each gate driver comprises:
an isolated amplifier; and
a drive circuit.

3. The vehicle of claim 2, wherein:
the isolated amplifier comprises:
a first input connected to the positive power-supply voltage;
a second input connected to the negative power-supply voltage;
a first output; and
a second output connected to the gate of the power switch; and
the drive circuit comprises:
a first resistor connected between the first output and the gate;
a second resistor and a capacitor connected in series between the first output an the gate of the power switch; and
a diode connected in parallel with the capacitor.

4. The vehicle of claim 2, wherein:
the isolated amplifier is configured to generate, based on the positive power-supply voltage, an output voltage; and
the drive circuit is configured to generate, based the output voltage of the isolated amplifier, the first current to include:
a switch current during a first time period; and
a hold current during a second time period following the first time period, wherein the switch current is greater than the hold current.

5. The vehicle of claim 4, wherein the gate driver is configured to adjust the hold current based on temperature.

6. The vehicle of claim 4, wherein the drive circuit comprises a resistor connected in series with the gate of the power switch and having a resistance that changes with temperature to adjust the hold current based on temperature.

7. The vehicle of claim 2, wherein the isolated amplifier is further configured to provide at the gate of the power switch a low impedance while the power switch is turned off.

8. The vehicle of claim 2, further comprising a controller configured to perform operations comprising controlling the isolated amplifier responsive to the first and second control inputs from the battery control module.

9. The vehicle of claim 8, wherein the operations further comprise controlling the isolated amplifier to adjust a hold current portion of the first current based on temperature.

10. The vehicle of claim 8, wherein the operations further comprise:
detecting excessive current in the gate driver; and
based on detecting the excessive current, turning the power switch off.

11. The vehicle of claim 2, further comprising an isolated power-supply circuit configured to generate the positive power-supply voltage and the negative power-supply voltage from the DC voltage.

12. The vehicle of claim 11, wherein the isolated power-supply circuit comprises one or more of external isolation windings or isolation windings embedded in a printed circuit board.

13. The vehicle of claim 1, further comprising an application specific integrated circuit (ASIC) comprising one or more of the plurality of gate drivers.

14. A circuit comprising:
a power switch comprising a gallium nitride (GaN) based gate injection transistor (GiT); and
a gate driver configured to:
responsive to a first control input from a controller, generate, from a positive power-supply voltage, a positive voltage and a first current at a gate of the power switch to turn the power switch on, wherein the first current comprises a switch current during a first time period and a hold current during a second time period following the first time period, wherein the switch current is greater than the hold current;
responsive to a second control input from the controller, generate, from a negative power-supply voltage, a negative voltage and a second current at the gate of the power switch to turn the power switch off; and
provide at the gate of the power switch a low impedance while the power switch is turned off.

15. The circuit of claim 14, wherein the gate driver comprises a drive circuit configured to generate the first current to include:
a switch current during a first time period; and
a hold current during a second time period following the first time period, wherein the switch current is greater than the hold current.

16. The circuit of claim 15, wherein the drive circuit comprises a resistor configured to have a resistance that changes with temperature to adjust the hold current based on temperature.

17. The circuit of claim 14, wherein the gate driver is configured to provide at the gate of the power switch a low impedance while the power switch is turned off.

18. The circuit of claim 14, wherein the gate driver comprises an isolated amplifier configured to, responsive to the first and second control inputs, generate the positive voltage and the negative voltage.

19. The circuit of claim 14, further comprising an isolated power-supply circuit configured to generate the positive power-supply voltage and the negative power-supply voltage from a DC voltage provided by a battery.

20. The circuit of claim 14, wherein the gate driver is configured to:
detect excessive current in the gate driver; and
based on detecting the excessive current, turn the power switch off.
